(19) United States
(12) Patent Application Publication
(10) Pub. No.: US 2021/0284504 A1
(43) Pub. Date: Sep. 16, 2021

(54) SPECIALIZED, PERSONALIZED & ENHANCED ELEVATOR CALLING FOR ROBOTS & CO-BOTS

(71) Applicant: OTIS ELEVATOR COMPANY, Farmington, CT (US)

(72) Inventors: Stephen Richard Nichols, Plantsville, CT (US); Michael P. Keenan, JR., Suffield, CT (US); James Sorrels, Orlando, FL (US); Sam Wong, Bridgeport, CT (US); Kayla Geer, New Britain, CT (US)

(21) Appl. No.: 16/819,233

(22) Filed: Mar. 16, 2020

(51) Int. Cl. B66B 25/00; B66B 3/00; B66B 5/00; B66B 5/02

(52) U.S. Cl. CPC B66B 25/003; B66B 3/006; B66B 2201/403; B66B 5/024; B66B 2201/23; B66B 5/0006

(57) ABSTRACT

A method of collecting data using a robot data collection system including: collecting data on a landing of a building using a sensor system of a robot; transmitting the data to a conveyance system of the building; and adjusting operation of the conveyance system in response to the data.

### BACKGROUND

The subject matter disclosed herein relates generally to the field of conveyance systems, and specifically to a method and apparatus for assisting individuals located proximate conveyance systems using robots.

Conveyance systems such as, for example, elevator systems, escalator systems, and moving walkways are typically only able to collect limited data using sensors hardwired to the conveyance system, which limits the ability of the conveyance system to collect data.

### BRIEF SUMMARY

According to an embodiment, a method of collecting data using a robot data collection system is provided. The method including: collecting data on a landing of a building using a sensor system of a robot; transmitting the data to a conveyance system of the building; and adjusting operation of the conveyance system in response to the data.

In addition to one or more of the features described herein, or as an alternative, further embodiments may include: moving the robot around the landing to collect the data.

In addition to one or more of the features described herein, or as an alternative, further embodiments may include that the conveyance system is an elevator system including an elevator car.

In addition to one or more of the features described herein, or as an alternative, further embodiments may include: moving the robot within an elevator lobby on the landing to collect the data.

In addition to one or more of the features described herein, or as an alternative, further embodiments may include: receiving an elevator call from the robot for the elevator car to transport the robot from the landing to a destination; detecting a location of the robot; detecting a travel speed of the robot; determining a distance from the location of the robot to the elevator system; determining a time of arrival of the robot at the elevator system in response to the location of the robot, the travel speed of the robot, and the distance from the location of the robot to the elevator system; and moving the elevator car to arrive at the landing at or before the time or arrival of the robot.

In addition to one or more of the features described herein, or as an alternative, further embodiments may include: detecting when the robot is located within the elevator car; and moving the elevator car to the destination.

In addition to one or more of the features described herein, or as an alternative, further embodiments may include: determining an identity of an individual; determining a destination of the individual in response to the identity; and transmitting an elevator call to a dispatcher of the elevator system for the elevator car to transport the individual from the landing to the destination.

In addition to one or more of the features described herein, or as an alternative, further embodiments may include that the identity of the individual is determined using at least one of: a voice of an individual captured using a microphone of the sensor system, an image of an individual captured using a camera of the sensor system, and a wireless signal indicating an identity of the individual detected using a communication module of the robot.

In addition to one or more of the features described herein, or as an alternative, further embodiments may include: detecting a number of individuals within an elevator lobby using at least one of a people detection system of the sensor system and a people counter device of the building; and transmitting an elevator call to a dispatcher of the elevator system in response to the number of individuals.

In addition to one or more of the features described herein, or as an alternative, further embodiments may include: detecting a number of individuals approaching an elevator lobby using at least one of a people detection system of the sensor system and a people counter device of the building; determining that a crowd has formed when the number of individuals is greater than or equal to a selected crowd size; and transmitting an elevator call to a dispatcher of the elevator system in response to the number of individuals.

In addition to one or more of the features described herein, or as an alternative, further embodiments may include: detecting a fire using a fire detection system of the sensor system; notifying a dispatcher of the elevator system of the fire; and operating the elevator system in an occupant evacuation operation mode.

According to another embodiment, a method of collecting data using a robot data collection system is provided. The method including: collecting data on a landing of a building using a sensor system of a robot; transmitting the data to a building system manager of the building; and adjusting operation of the building system manager in response to the data.

In addition to one or more of the features described herein, or as an alternative, further embodiments may include: moving the robot around the landing to collect the data.

In addition to one or more of the features described herein, or as an alternative, further embodiments may include: detecting a fire using a fire detection system of the sensor system; notifying the building system manager of the fire; and activating a fire alarm of the building system manager.

In addition to one or more of the features described herein, or as an alternative, further embodiments may include: detecting a problem condition using the sensor system; and notifying the building system manager of the problem condition.

In addition to one or more of the features described herein, or as an alternative, further embodiments may include: capturing an image of an individual using a camera of the sensor system; determining an identity of the individual in response to the image; determining whether the individual is an intruder in response to the identity; and activating an intruder alert of the building system manager.

In addition to one or more of the features described herein, or as an alternative, further embodiments may include detecting an individual within the building at an unauthorized time using a people counting system of the sensor system; and activating an intruder alert of the building system manager.

In addition to one or more of the features described herein, or as an alternative, further embodiments may include: transmitting the data to a conveyance system of the building; and adjusting operation of the conveyance system in response to the data.

According to another embodiment, a method of calling an elevator car of an elevator system for a robot is provided. The method including: receiving an elevator call from the robot at a first time, the elevator call being for the elevator car to transport the robot from the landing to a destination; obtaining a known schedule of the robot or a known location of the robot at the first time; determining a location of the robot at the first time in response to the known schedule of the robot or the known location of the robot at the first time; obtaining a known travel speed of the robot; determining a time of arrival of the robot at the elevator system in response to at least the location of the robot at the first time, the travel speed of the robot, and a location of the elevator system; and moving the elevator car to arrive at the landing at or before the time or arrival of the robot.

In addition to one or more of the features described herein, or as an alternative, further embodiments may include: determining whether the robot arrived at the location of the elevator system; and adjusting operation of the elevator system in response to whether the robot arrived at the location of the elevator system.

Technical effects of embodiments of the present disclosure include using a robot to collect sensor data throughout the building and relay back the data to the conveyance system.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates a schematic view of a robot data collection system used to assist individuals, in accordance with an embodiment of the disclosure;

FIG. 3 is a flow chart of method of collecting data using a robot data collection system of FIG. 2, in accordance with an embodiment of the disclosure;

FIG. 4 is a flow chart of method of collecting data using a robot data collection system of FIG. 2, in accordance with an embodiment of the disclosure; and

FIG. 5 is a flow chart of method of calling an elevator car of an elevator system for a robot.

### DETAILED DESCRIPTION

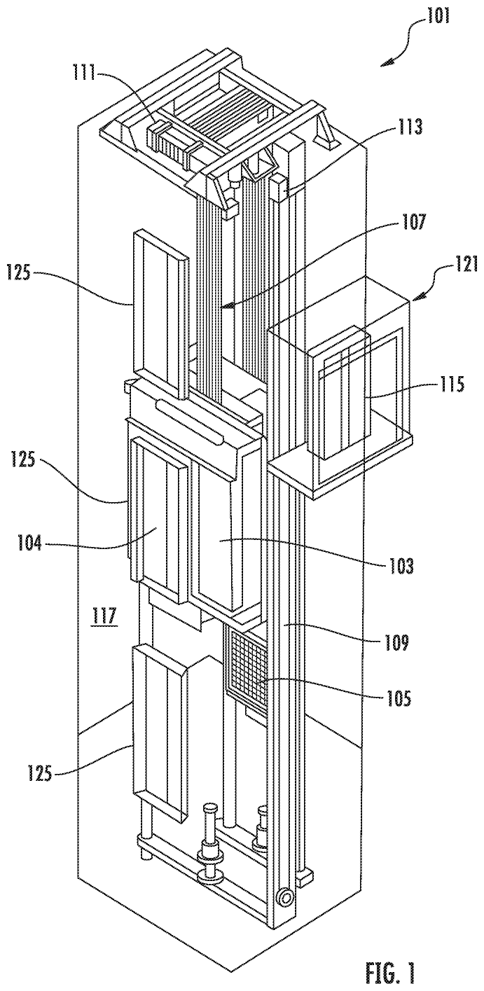

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

In other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1. In one example, embodiments disclosed herein may be applicable conveyance systems such as an elevator system 101 and a conveyance apparatus of the conveyance system such as an elevator car 103 of the elevator system 101. In another example, embodiments disclosed herein may be applicable conveyance systems such as an escalator system and a conveyance apparatus of the conveyance system such as a moving stair of the escalator system.

The elevator system 101 also includes one or more elevator doors 104. The elevator door 104 may be integrally attached to the elevator car 103 and/or the elevator door 104 may be located on a landing 125 of the elevator system 101. Embodiments disclosed herein may be applicable to both an elevator door 104 integrally attached to the elevator car 103 and/or an elevator door 104 located on a landing 125 of the elevator system 101. The elevator door 104 opens to allow passengers to enter and exit the elevator car 103.

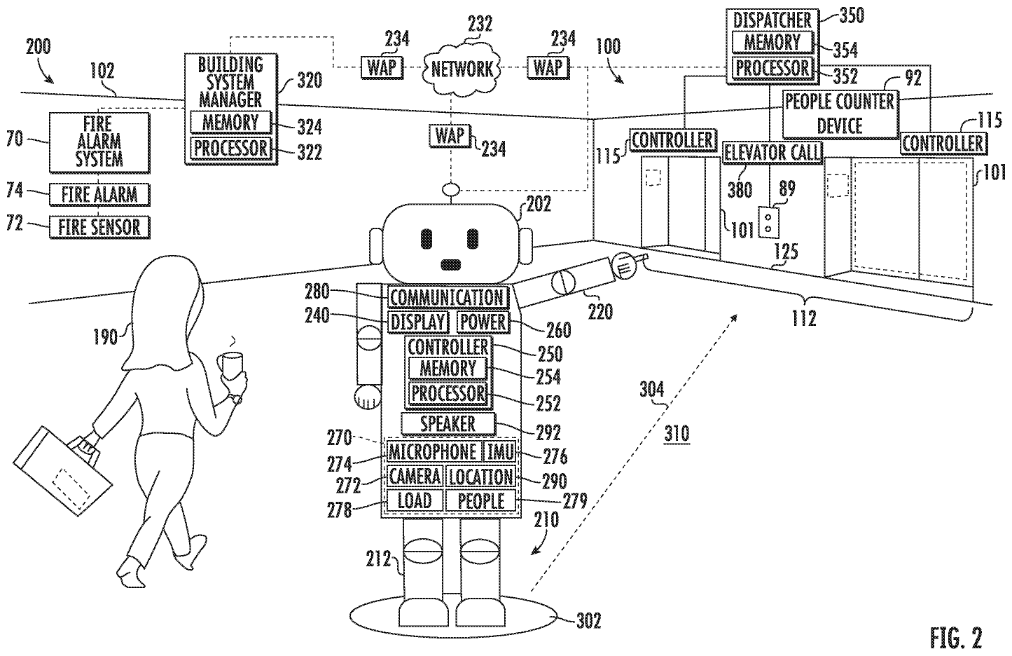

Referring now to FIG. 2, with continued reference to FIG. 1, a robot data collection system 200 is illustrated, in accordance with an embodiment of the present disclosure. It should be appreciated that, although particular systems are separately defined in the schematic block diagrams, each or any of the systems may be otherwise combined or separated via hardware and/or software. The robot data collection system 200 comprises and/or is in wireless communication with a robot 202. It is understood that one robot 202 is illustrated, the embodiments disclosed herein may be applicable to a data collection system 200 having one or more robots 202. The robot 202 may be configured to act as an extension of the building elevator system 100 and/or building system manager 320 by collecting data for at least one of the building elevator system 100 and/or building system manager 320.

It is understood that while elevator systems 101 are utilized for exemplary illustration, embodiments disclosed herein may be applied to other conveyance systems utilizing conveyance apparatuses for transportation such as, for example, escalators, moving walkways, etc.

As illustrated in FIG. 2, a building elevator system 100 within a building 102 may include multiple different individual elevator systems 101 organized in an elevator bank 112. The elevator systems 101 include an elevator car 103 (not shown in FIG. 2 for simplicity). It is understood that while two elevator systems 101 are utilized for exemplary illustration, embodiments disclosed herein may be applied to building elevator systems 100 having one or more elevator systems 101. Further, the elevator systems 101 illustrated in FIG. 2 are organized into an elevator bank 112 for ease of explanation but it is understood that the elevator systems 101 may be organized into one or more elevator banks 112. Each of the elevator banks 112 may contain one or more elevator systems 101. Each of the elevator banks 112 may also be located on different landings 125.

The landing 125 in the building 102 of FIG. 2 may have an elevator call device 89 located proximate the elevator systems 101. The elevator call device 89 transmits an elevator call 380 to a dispatcher 350 of the building elevator system 100. It should be appreciated that, although the dispatcher is separately defined in the schematic block diagrams, the dispatcher 350 may be combined via hardware and/or software in any controller 115 or other device. The elevator call 380 may include the source of the elevator call 380. The elevator call device 89 may include a destination entry option that includes the destination of the elevator call 380. The elevator call device 89 may be a push button and/or a touch screen and may be activated manually or automatically. For example, the elevator call 380 may be sent by an individual 190 or a robot 202 entering the elevator call 380 via the elevator call device 89. The elevator call device 89 may also be a mobile device configured to transmit an elevator call 380 and a robot 202 may be in possession of said mobile device to transmit the elevator call 380. The mobile device may be a smart phone, smart watch, laptop, or any other mobile device known to one of skill in the art. As illustrated in FIG. 2, the robot 202 may utilize a communication module 280 to communicate either directly to the building elevator system 100 and/or indirectly with the building elevator system 100 through a computing network 232.

The controllers 115 can be combined, local, remote, cloud, etc. The dispatcher 350 may be local, remote, cloud, etc. The dispatcher 350 is in communication with the controller 115 of each elevator system 101. Alternatively, there may be a single controller that is common to all of the elevator systems 101 and controls all of the elevator system 101, rather than two separate controllers 115, as illustrated in FIG. 2. The dispatcher 350 may be a ‘group’ software that is configured to select the best elevator car 103 to be assigned to the elevator call 380. The dispatcher 350 manages the elevator call devices 89 related to the elevator bank 112.

The dispatcher 350 is configured to control and coordinate operation of multiple elevator systems 101. The dispatcher 350 may be an electronic controller including a processor 352 and an associated memory 354 comprising computer-executable instructions that, when executed by the processor 352, cause the processor 352 to perform various operations. The processor 352 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 354 may be but is not limited to a random access memory (RAM), read only memory (ROM), or other electronic, optical, magnetic or any other computer readable medium.

The dispatcher 350 is in communication with the elevator call devices 89 of the building elevator system 100. The dispatcher 350 is configured to receive the elevator call 380 transmitted from the elevator call device 89 and/or the robot 202. The dispatcher 350 is configured to manage the elevators calls 380 coming in from the elevator call device 89 and/or the robot 202 then command one or more elevator systems 101 to respond to elevator call 380.

The robot 202 may be configured to operate fully autonomously using a controller 250 to control operation of the robot 202. The controller 250 may be an electronic controller that includes a processor 252 and an associated memory 254 including computer-executable instructions that, when executed by the processor 252, cause the processor 252 to perform various operations. The processor 252 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 254 may be a storage device such as, for example, a random access memory (RAM), read only memory (ROM), or other electronic, optical, magnetic or any other computer readable medium.

The robot 202 includes a power source 260 configured to power the robot 202. The power source 260 may include an energy harvesting device and/or an energy storage device. In an embodiment, the energy storage device may be an onboard battery system. The battery system may include but is not limited to a lithium ion battery system. The robot 202 may be configured to move to an external power source (e.g., electrical outlet) to recharge the power source 260.

The robot 202 includes a speaker 292 configured to communicate audible words, music, and/or sounds to individuals 190 located proximate the robot 202. The robot 202 also includes a display device 240 configured to display information visually to individuals 190 located proximate the robot 202. For example, the display device 240 may be a flat screen monitor, a computer tablet, or smart phone device. In an embodiment, the display device 240 may be located on the head of the robot 202 or may replace the head of the robot 202. In an embodiment, the display device 240 a computer tablet or similar display device that is carried by the robot 202.

The robot 202 may be stationed (i.e., located) permanently or temporarily within an elevator lobby 310 that is located on the landing 125 proximate the elevator system 101. The robot 202 may include a propulsion system 210 to move the robot 202. The robot 202 may move throughout the elevator lobby 310, move away from the elevator lobby 310 throughout the landing 125, and/or may move to other landings via the elevator system 101 and/or a stair case (not shown). The propulsion system 210 may be a leg system, as illustrated in FIG. 2, that simulates human legs. As illustrated in FIG. 2, the propulsion system 210 may include two or more legs 212, which are used to move the robot 202. It is understood that while the leg system is utilized for exemplary illustration, embodiments disclosed herein may be applied to robots having other propulsion systems for transportation such as, for example, a wheel system, a rotorcraft system, a hovercraft system, a tread system, or any propulsion system may be known of skill in the art may be utilized. It is also understood that a robot 202 having a humanoid appearance is utilized for exemplary illustration, embodiments disclosed herein may be applied to robots that do not have a humanoid appearance.

The robot 202 includes a sensor system 270 to collect sensor data. The sensor system 270 may include, but is not limited, to an inertial measurement unit (IMU) sensor 276, a camera 272, a microphone 274, a location sensor system 290, a fire detection system 278, and a people counter system 279. The IMU sensor 276 is configured to detect accelerations of the robot 202. The IMU sensor 276 may be a sensor such as, for example, an accelerometer, a gyroscope, or a similar sensor known to one of skill in the art. The IMU sensor 276 may detect accelerations as well as derivatives or integrals of accelerations, such as, for example, velocity, jerk, jounce, snap . . . etc.

The camera 272 may be configured to capture images of areas surrounding the robot 202. The camera 272 may be a still image camera, a video camera, depth sensor, thermal camera, and/or any other type of imaging device known to one of skill in the art. In one embodiment, the controller 250 may be configured to analyze the images captured by the camera 272 using image recognition to identify an individual 190. In another embodiment, the controller 250 may be configured to transmit the images as raw data for processing by the building system manager 320. The image recognition may identify the individual 190 using facial recognition. When an individual 190 is identified as a specific person, then the robot 202 may transmit an elevator call 380 to the dispatcher 350. For example, the image recognition may identify the individual 190 is a very important person (VIP), such as the CEO of the company, that works on the seventh floor and then the robot 202 may transmit an elevator call 380 so that an elevator car 103 and ready to pick up the CEO when the CEO arrives at the elevator bank 112.

The microphone 274 is configured to detect sound. The microphone 274 is configured to detect audible sound proximate the robot 202, such as, for example, language spoken an individual 190 proximate the robot 202 or sound that is outside the range of human hearing produced by non-humans. In one embodiment, the controller 250 may be configured to analyze the sound captured by the microphone 274 using language recognition software and respond accordingly. In another embodiment, the controller 250 may be configured to transmit the sound as raw data for processing by the building system manager 320. The sound (i.e., voice) from an individual 190 may be analyzed to identify the individual 190 using voice recognition.

In one embodiment, the controller 250 may be configured to analyze the sound captured by the microphone 274 using voice recognition to identify an individual 190. In another embodiment, the controller 250 may be configured to transmit the sound as raw data for processing by the building system manager 320. When an individual 190 is identified as a specific person, then the robot 202 may transmit an elevator call 380 to the dispatcher 350. For example, the voice recognition may identify the individual 190 as the CEO of the company that works on the seventh floor and then the robot 202 may transmit an elevator call 380 so that an elevator car 103 and ready to pick up the CEO when the CEO arrives at the elevator bank 112.

The robot 202 also includes a location sensor system 290 configured to detect a location 302 of the robot 202. The location 302 of the robot 202 may also include the location 302 of the robot 202 relative to other objects in order allow the robot 202 to navigate through hallways of a building 102 and prevent the robot 202 from bumping into objects or individuals 190. The location sensing system 290 may use one or a combination or sensing devices including but not limited to GPS, wireless signal triangulation, SONAR, RADAR, LIDAR, image recognition, or any other location detection or collision avoidance system known to one of skill in the art. The location sensor system 290 may utilize GPS in order to detect a location 302 of the robot 202. The location sensor system 290 may utilize triangulation of wireless signals within the building 102 in order to determine a location 302 of the robot 202 within a building 102. For example, the location sensor system 290 may triangulate the position of the robot 202 within a building 102 utilizing received signal strength (e.g., RSSI) of wireless signals from WAPs 234 in known locations throughout the building 102. In order to avoid colliding with objects, the location sensor system 290 may additionally use SONAR, RADAR, LIDAR, or image recognition (Convolutional Neural Networks). Upon initial deployment or a location reset, the robot 202 may perform a learn mode, such that the robot 202 may become familiar with the environment.

In an embodiment, where the dispatcher 350 and/or elevator system 101 receives an initialization of the elevator call 380, by knowing which device is placing the call and where that device is initiated a call from, the conveyance system can adjust its operation in response.

The location 302 of the robot 202 may also be communicated to the dispatcher 350 when the robot 202 desires to use the elevator system 101. By knowing the location 302 of the robot 202, the distance away from the elevator bank 112 (e.g., elevator system 101) along a probable path 304, and the movement speed of the robot 202, then the dispatcher 350 may call an elevator car 103 to arrive at the elevator bank 112 at or before the robot 202 arrives at the elevator bank 112. Use of the elevator systems 101 may be limited to learnt periods of low traffic of individuals 190. The traffic patterns of individuals 190 may be learnt using the people counter system 279 or a people counter device 92 that may detect movement of individuals over a period of time to learn traffic patterns.

The robot 202 includes a communication module 280 configured to allow the controller 250 of the robot 202 to communicate with the building system manager 320 and the dispatcher 350. The communication module 280 is capable of transmitting and receiving data to and from the dispatcher 350 through a computer network 232. The computer network 232 may be a cloud computing network. The communication module 280 is capable of transmitting and receiving data to and from the building system manager 320 through the computer network 232. In another embodiment, the communication module 280 is capable of transmitting and receiving data to and from the dispatcher 350 by communicating directly with the dispatcher 350.

The communication module 280 may communicate to the computer network 232 through a wireless access protocol device (WAP) 234 using short-range wireless protocols. Short-range wireless protocols may include, but not are limited to, Bluetooth, Wi-Fi, HaLow (801.11ah), zWave, ZigBee, or Wireless M-Bus. Alternatively, the communication module 280 may communicate directly with the computer network 232 using long-range wireless protocols. Long-range wireless protocols may include, but are not limited to, cellular, LTE (NB-IoT, CAT M1), LoRa, satellite, Ingenu, or SigFox.

The communication module 280 may communicate to the dispatcher 350 through a WAP 234 using short-range wireless protocols. Alternatively, the communication module 280 may communicate directly with the dispatcher 350 using short-range wireless protocols.

The building system manager 320 may communicate to the computer network 232 through a WAP 234 using short-range wireless protocols. the building system manager 320 may communicate directly with the computer network 232 using long-range wireless protocols.

The building system manager 320 is an electronic controller that includes a processor 322 and an associated memory 324 including computer-executable instructions that, when executed by the processor 322, cause the processor 322 to perform various operations. The processor 322 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 324 may be a storage device such as, for example, a random access memory (RAM), read only memory (ROM), or other electronic, optical, magnetic or any other computer readable medium.

The building system manager 320 may be configured to obtain, store, and provide to the robot 202 information that may be useful to the robot 202. The information may include a directory of the building 102 processor including images of individuals 190 that may be used for facial recognition or voice signatures of individuals 190 that may be used for voice recognition of individuals 190 to call an elevator cars 103 for the individuals 190, as described above. The information may also include directory information of people or locations within the building 102 and/or in the area surrounding the building 102. The building system manager 320 may also perform climate control within the building 102 and/or building access control for the building 102.

The building system manager 320 may also be in communication with a fire alarm system 70 within the building 102. The fire alarm system 70 is configured to detect a fire and the fire alarm system 70 may report this fire to the building system manager 320. The fire alarm system 70 may include a plurality of fire sensors 72 configured to detect a fire. The fire sensors 72 may include a smoke detector, a heat sensor, a manual pull fire station, or any similar device known to one of skill in the art. The fire sensors 72 may be located on each landing 125 of the building 102. The fire alarm system 70 may also include a plurality of fire alarms 74 configured to activate an alarm when a fire is detected by the fire sensors 72. The alarm produced by the fire alarms 74 may be audible and/or visual (e.g., flashing lights and/or a siren).

The fire detection system 278 of the robot 202 may include similar equipment to that of the fire sensors 72, however, advantageously the robot 202 is free to move throughout the building 102 rather than being tied to a particular location. Advantageously, this leads to earlier detection of a fire and more coverage of overall fire detection within the building 102. The fire detection system 278 of the robot 202 may include a smoke detector, a heat sensor, or any similar device known to one of skill in the art that may be used to detect a fire. When the fire detection system 278 of the robot 202 detects a fire, the robot 202 is configured to notify the building systems manager 320 and the building system manager 320 may notify the fire alarm system 70 to activate the fire alarm 74. The robot 202 may also transmit the location where the fire was detected to the building system manager 320. In one embodiment, the controller 250 may be configured to analyze the data captured by the fire detection system 278 to determine whether a fire is present. In another embodiment, the controller 250 may be configured to transmit the data captured by the fire detection system 278 as raw data for processing by the building system manager 320 to determine whether a fire is present.

In addition to fires, the robot 202 may also be able to report other problems encountered within the building 102, such as, for example flooding, biohazards, or hot/cold spots in a building. The sensor system 270 may additionally include a humidity sensor and the robot 202 may utilize the humidity sensor and/or the camera 272 to detect flooding within the building 102. The sensor system 270 may additionally include a biohazard sensor and the robot 202 may utilize the biohazard to detect biohazards within the building 102.

The people counter system 279 is configured to detect or determine a people count. The people count may be a number of individuals 190 located on a landing 125 or more specifically a number of individuals 190 located in an elevator lobby 310 on a landing 125. The people count may be an exact number of individuals 190 or an approximate number of individuals 190.

The people counter system 279 may utilize the camera 272 for people counting. The people counter system 279 may be used to determine a number of individuals 190 proximate the elevator systems 101, a number of individuals 190 within an elevator lobby 310 proximate the elevator systems 101, and/or a number of individuals 190 on their way to the elevator system 101. Individuals 190 being located proximate the elevator system 101 and/or within the elevator lobby 310 is indicative that the individuals 190 would like to board an elevator car 103 of the elevator system 101.

The people counter system 279 may utilize one or more detection mechanisms of the robot 202, such as, for example the camera 272, a depth sensing device, a radar device, a laser detection device, a mobile device (e.g., cell phone) tracker using the communication device 280, and/or any other desired device capable of sensing the presence of individuals 190. The people counter system 279 utilizes the camera 272 for visual recognition to identify individual individuals 190 and objects in elevator lobby 310. The laser detection device may detect how many passengers walk through a laser beam to determine the number of individuals 190. The thermal detection device may be an infrared or other heat sensing camera that utilizes detected temperature to identify individual individuals 190 and objects and then determine the number of individuals 190. The depth detection device may be a 2-D, 3-D or other depth/distance detecting camera that utilizes detected distance to an object and/or individuals 190 to determine the number of individuals 190. The communication device 280 may act as a mobile device tracker may determine a number of individuals 190 on a landing 125 or in elevator lobby 310 by detecting mobile device wireless signals and/or detecting how many mobile devices are utilizing a specific application on the mobile device within the building 102 on the landing 125. As may be appreciated by one of skill in the art, in addition to the stated methods, additional methods may exist to sense the number of individuals 190 and one or any combination of these methods may be used to determine the number of individuals 190 in the elevator lobby 310, on the landing 125, or on their way to the elevator system 101.

In one embodiment, the people counter system 279 is able to detect the people count through image pixel counting. The people count may compare a current image of the elevator lobby 310 to a stock image of the elevator lobby 310. For example, the people counter system 279 may utilize pixel counting by capturing a current image of the elevator lobby 310 and comparing the current image of the elevator lobby 310 to a stock image of the elevator lobby 310 that illustrates the elevator lobby 310 with zero individuals 190 present or a known number of individuals 190 present. The number of pixels that are different between the stock image of the elevator lobby 310 and the current image of the elevator lobby 310 may correlate with the people count within the elevator lobby 310. It is understood that the embodiments disclosed herein are not limited to pixel counting to determine a people count and thus a people count may be determined utilizing other method including but not limited to video analytics software. Video analytics may identify individuals 190 from stationary objections and count each person separately to determine a total number of individuals 190.

The people count may be determined using a machine learning, deep learning, and/or artificial intelligence module. The artificial intelligence module can be located in the robot 202, within the building system manager 320 or dispatcher 350. The people count may alternatively be expressed as a percentage from zero-to-one-hundred percent indicating what percentage of pixels are different between the stock image of the elevator lobby 310 and the current image of the elevator lobby 310. The people count of the elevator lobby 310 may be expressed as a scale of one-to-ten (e.g., one being empty and ten being full) indicating what percentage of pixels are different between the stock image of the elevator lobby 310 and the current image of the elevator lobby 310. The people count may be expressed as an actual or estimated number of individuals 190, which may be determined in response to the number of pixels that are different between the stock image of the elevator lobby 310 and the current image of the elevator lobby 310.

The landing 125 in the building 102 of FIG. 2 may also include a people counter device 92 that works in collaboration with the people counter system 279 of the robot 202 to determine the people count. The people counter device 92 may include one or more detection mechanisms in the elevator lobby 310, such as, for example a weight sensing device, a visual recognition device, depth sensing device, radar device, a laser detection device, mobile device (e.g., cell phone) tracking, and/or any other desired device capable of sensing the presence of individuals 190. The visual recognition device may be a camera that utilizes visual recognition to identify individual individuals 190 and objects in elevator lobby 310. The weight detection device may be a scale to sense the amount of weight in an elevator lobby 310 and then determine the number of individuals 190. The laser detection device may detect how many passengers walk through a laser beam to determine the number of individuals 190 in the elevator lobby 310. The thermal detection device may be an infrared or other heat sensing camera that utilizes detected temperature to identify individual individuals 190 and objects in the elevator lobby 310 and then determine the number of individuals 190. The depth detection device may be a 2-D, 3-D or other depth/distance detecting camera that utilizes detected distance to an object and/or individuals 190 to determine the number of passengers. The mobile device tracking may determine a number of individuals 190 on a landing 125 or in elevator lobby 310 by detecting mobile device wireless signals and/or detecting how many mobile devices are utilizing a specific application on the mobile device within the building 102 on the landing 125 or in the elevator lobby 310. As may be appreciated by one of skill in the art, in addition to the stated methods, additional methods may exist to sense the number of individuals 190 and one or any combination of these methods may be used to determine the number of individuals 190 in the elevator lobby 310 or on the landing 125.

In one embodiment, the people counter device 92 is able to detect the people count through image pixel counting. The people count may compare a current image of the elevator lobby 310 to a stock image of the elevator lobby 310. For example, the people counter device 92 may utilize pixel counting by capturing a current image of the elevator lobby 310 and comparing the current image of the elevator lobby 310 to a stock image of the elevator lobby 310 that illustrates the elevator lobby 310 with zero individuals 190 present or a known number of individuals 190 present. The number of pixels that are different between the stock image of the elevator lobby 310 and the current image of the elevator lobby 310 may correlate with the people count within the elevator lobby 310. It is understood that the embodiments disclosed herein are not limited to pixel counting to determine a people count and thus a people count may be determined utilizing other method including but not limited to video analytics software. Video analytics may identify individuals 190 from stationary objections and count each person separately to determine a total number of individuals 190.

The people count may be determined using a machine learning, deep learning, and/or artificial intelligence module. The artificial intelligence module can be located in the people counter device 92 or in a separate module in the dispatcher 350. The separate module may be able to communicate with the people counter device 92. The people count may alternatively be expressed as a percentage from zero-to-one-hundred percent indicating what percentage of pixels are different between the stock image of the elevator lobby 310 and the current image of the elevator lobby 310. The people count of the elevator lobby 310 may be expressed as a scale of one-to-ten (e.g., one being empty and ten being full) indicating what percentage of pixels are different between the stock image of the elevator lobby 310 and the current image of the elevator lobby 310. The people count may be expressed as an actual or estimated number of individuals 190, which may be determined in response to the number of pixels that are different between the stock image of the elevator lobby 310 and the current image of the elevator lobby 310.

The people count determined by at least one of people counter system 279 of the robot 202 and the people counter device 92 may be transmitted to the dispatcher 350 to adjust operation of the elevator systems 101. For example, if the people count is high meaning that there are a large number of individuals 190 then the dispatcher 350 will send more elevator cars 103 to the elevator lobby 310.

Advantageously, the robot 202 is able to move away from the elevator lobby 310 and thus may be able to detect crowds of individuals 190 in advance of the crowd of individuals 190 reaching the elevator lobby 310. The crowd of individuals 190 the dispatcher 350 may then be reported to the dispatcher 350 and the dispatcher 350 may call elevators cars 103 in advance of the crowd of individuals 190 reaching the elevator lobby 310, which advantageously saves time by helping to clear out the crowd of individuals 190 from the elevator lobby 310 faster.

Additionally, the robot 202 may also serve as a security guard for the building 102 by utilizing the people counter system 279 and/or the camera 272 to detect individuals 190 that should not be located in the building 102. In one example, the camera 272 may be utilized identify each individual 190 within the building 102 through facial recognition and if the individual 190 is not authorized to be in the building 102 or a specific section/room of the building 102 (i.e., determined to be an intruder) then the robot 202 may activate an intruder alert and/or contact the building system manager 320. The intruder alert may be a visual light display or an audible alarm of the building system manager 320. The facial recognition determination may be compared to a database images of individuals 190 authorized to be within the building 102 and/or database images of individuals 190 not authorized to be within the building 102. If the building 102 has multiple different sections or landings 125 with different security requirements then robot 202 may be configured to travel throughout the building 102 to ensure that individuals 190 are authorized to be in the section or room of the building 102. Further, if individuals 190 are detected within the building 102 at unusual times or unauthorized times, then the robot 202 may activate an intruder alert and/or contact the building system manager 320. For example, if an individual 190 is detected after the building 102 has closed then the robot 202 may activate an intruder alert and/or contact the building system manager 320.

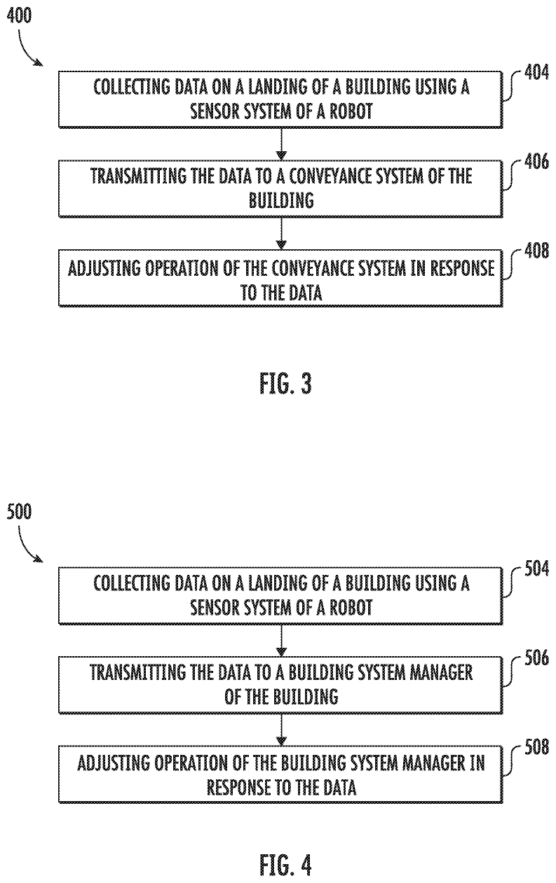

Referring now to FIG. 3, while referencing components of FIGS. 1 and 2. FIG. 3 shows a flow chart of method 400 of collecting data using a robot data collection system 200 of FIG. 2, in accordance with an embodiment of the disclosure. In an embodiment, the method 400 is performed by the robot data collection system 200 of FIG. 2.

At block 404, data is collected on a landing 125 of a building 102 using a sensor system 270 of a robot 202. The robot 202 may move around the landing 125 to collect the data. In an embodiment, the conveyance system is an elevator system 101 comprising an elevator car 103. The robot 202 may be moved within an elevator lobby 310 on the landing 125 to collect the data.

At block 406, the data is transmitted to a conveyance system of the building 102. At block 408, operation of the conveyance system is adjusted in response to the data.

The method 400 may further comprise that an elevator call 380 is received from the robot 202 for the elevator car 103 to transport the robot 202 from the landing 125 to a destination (i.e., a landing 125 that the robot 202 would like to travel to), a location 302 of the robot 202 is detected, a travel speed of the robot 202 is detected, a distance from the location 302 of the robot 202 to the elevator system 101 is determined, a time of arrival of the robot 202 at the elevator system 101 is determined in response to the location 302 of the robot 202, the travel speed of the robot 202 is detected, and the distance from the location 302 of the robot 202 to the elevator system 101, and the elevator car 103 is moved to arrive at the landing 125 at or before the time or arrival of the robot 202. The method 400 may further comprise that it is detected when the robot 202 is located within the elevator car 103 and then the elevator car 103 is moved to the destination.

The method 400 may also comprise that an image of an individual 190 is captured using a camera 272 of the sensor system 270, an identity of the individual 190 is determined in response to the image, a destination of the individual 190 is determined in response to the identity, and an elevator call 380 is transmitted to a dispatcher 350 of the elevator system 101 for an elevator car 103 to transport the individual 190 from the landing 125 to the destination.

The method 400 may also comprise that a voice of an individual 190 is captured using a microphone 274 of the sensor system 270, an identity of the individual 190 is determined in response to the voice, a destination of the individual 190 is determined in response to the identity, and an elevator call 380 is transmitted to a dispatcher 350 of the elevator system 101 for an elevator car 103 to transport the individual 190 from the landing 125 to the destination.

The method 400 may also comprise that a wireless signal indicating an identity of the individual 190 is captured using a communication module 280 of the robot 202, an identity of the individual 190 is determined in response to the wireless signal, a destination of the individual 190 is determined in response to the identity, and an elevator call 380 is transmitted to a dispatcher 350 of the elevator system 101 for an elevator car 103 to transport the individual 190 from the landing 125 to the destination. The wireless signal may be from a radio frequency identification (RFID) tag being carried by the individual 190 or from a mobile device (e.g., smart phone) being carried by the individual 190.

The method 400 may further comprise that a number of individuals 190 is detected within the elevator lobby 310 using a people detection system 279 of the sensor system 270, an elevator call 380 is transmitted to a dispatcher 350 of the elevator system 101 in response to the number of individuals 190.

The method 400 may further comprise that a number of individuals 190 is detected approaching the elevator lobby 310 using a people detection system 279 of the sensor system 270 and an elevator call 380 is transmitted to a dispatcher 350 of the elevator system 101 in response to the number of individuals 190. It may additionally be determined that a crowd has formed when the number of individuals is greater than or equal to a selected crowd size.

The method 400 may further comprise that a fire is detected using a fire detection system 278 of the sensor system 270, a dispatcher 350 of the elevator system 101 is notified of the fire, and the elevator system 101 is operated in an occupant evacuation operation mode, which coordinates the evacuation of individuals 190 from the building 102.

While the above description has described the flow process of FIG. 3 in a particular order, it should be appreciated that unless otherwise specifically required in the attached claims that the ordering of the steps may be varied.

Referring now to FIG. 4, while referencing components of FIGS. 1 and 2. FIG. 4 shows a flow chart of method 500 of collecting data using a robot 202 data collection system 200 of FIG. 2, in accordance with an embodiment of the disclosure. In an embodiment, the method 500 is performed by the robot 202 data collection system 200 of FIG. 2.

At block 504, data is collected on a landing 125 of a building 102 using a sensor system 270 of a robot 202. The robot 202 may be moved around the landing 125 to collect the data. At block 506, the data is transmitted to a building system manager 320 of the building 102. At block 508, operation of the building system manager 320 is adjusted in response to the data.

The method 500 may also comprise that a fire is detected using a fire detection system 278 of the sensor system 270, the building manager 320 is notified of the fire, and a fire alarm 74 is activated.

The method 500 may also comprise that a problem condition is detected using the sensor system 270 and the building manager 320 is notified of the problem condition. A problem condition may include a fire, flooding, smoke, spill, mess, necessary repair or any other problem condition within the building 102 that may be encountered by the robot 202.

The method 500 may further comprise that a dispatcher 350 of an elevator system 101 within the building 102 is notified of the fire and then the elevator system 101 is operated in an occupant evacuation operation mode, which coordinates the evacuation of individuals 190 from the building 102.

The method 500 may further comprise that an image of an individual 190 is captured using a camera 272 of the sensor system 270 and an identity of the individual 190 is determined in response to the image. It may be determined that the individual 190 is an intruder in response to the identity and then an intruder alert of the building system manager 320 may be activated.

The method 500 may further comprise that an individual 190 is detected within the building 102 at an unauthorized time using a people counting system 279 of the sensor system 270 and then an intruder alert of the building system manager 320 is activated.

The method 500 may further comprise that the data is transmitted to a conveyance system of the building 102 and then operation of the conveyance system is adjusted in response to the data. In an embodiment, the conveyance system is an elevator system 101 comprising an elevator car 103.

While the above description has described the flow process of FIG. 4 in a particular order, it should be appreciated that unless otherwise specifically required in the attached claims that the ordering of the steps may be varied.

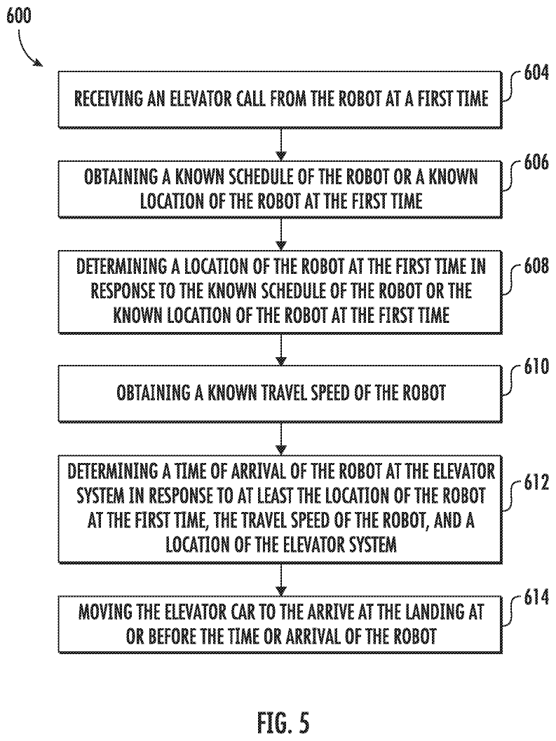

Referring now to FIG. 5, while referencing components of FIGS. 1 and 2. FIG. 5 shows a flow chart for a method 600 of calling an elevator car 103 of an elevator system 101 for a robot 202, in accordance with an embodiment of the disclosure. In an embodiment, the method 400 is performed by the robot data collection system 200 of FIG. 2.

At block 604, an elevator call 380 from the robot 202 at a first time. The elevator call 380 being for the elevator car 103 to transport the robot 202 from the landing 125 to a destination (e.g., another landing).

At block 606, a known schedule of the robot 202 or a known location of the robot 202 at the first time is obtained. For example, the known schedule of the robot 202 may depict where the robot 202 should be in the building 102 at any given time. The known schedule may be stored in the building system manager 320.

At block 608, a location 302 of the robot 202 at the first time is determined in response to the known schedule of the robot 202 or the known location of the robot 202 at the first time.

At block 610, a known travel speed of the robot 202 of the robot is obtained. The known travel speed of the robot 202 may be stored in the building system manager 320.

At block 612, a time of arrival of the robot 202 at the elevator system 101 is determined in response to at least the location of the robot 202 at the first time, the travel speed of the robot 202, and a location of the elevator system.

At block 614, the elevator car 103 is moved to arrive at the landing 125 at or before the time or arrival of the robot 202.

The method 600 may further comprise that it is determined whether the robot 202 arrived at the location of the elevator system 101 and operation of the elevator system 101 is adjusted in response to whether (and when) the robot 202 arrived at the location of the elevator system 101. For example, if it is determined that the robot 202 arrived at the location of the elevator system 101, then the elevator system 101 may take the robot 202 to the destination via an elevator car 103. In another example, if it is determined that the robot 202 has not arrived at the location of the elevator system 101, an alarm may be activated indicating that the robot 202 is lost/missing or for potential unauthorized use of a credential of the robot 202. In yet another example, if it is determined that the robot 202 has arrived at the location of the elevator system 101 extremely early then the elevator system 101 may determine that another elevator car 101 has already transported the robot 202.

The above description has described the flow process of FIG. 5 in a particular order, it should be appreciated that unless otherwise specifically required in the attached claims that the ordering of the steps may be varied.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of collecting data using a robot data collection system, the method comprising:
collecting data on a landing of a building using a sensor system of a robot;
transmitting the data to a conveyance system of the building; and
adjusting operation of the conveyance system in response to the data.

2. The method of claim 1, further comprising:
moving the robot around the landing to collect the data.

3. The method of claim 1, wherein the conveyance system is an elevator system comprising an elevator car.

4. The method of claim 3, further comprising:
moving the robot within an elevator lobby on the landing to collect the data.

5. The method of claim 3, further comprising:
receiving an elevator call from the robot for the elevator car to transport the robot from the landing to a destination;
detecting a location of the robot;
detecting a travel speed of the robot;
determining a distance from the location of the robot to the elevator system;
determining a time of arrival of the robot at the elevator system in response to the location of the robot, the travel speed of the robot, and the distance from the location of the robot to the elevator system; and
moving the elevator car to arrive at the landing at or before the time or arrival of the robot.

6. The method of claim 5, further comprising:
detecting when the robot is located within the elevator car; and
moving the elevator car to the destination.

7. The method of claim 3, further comprising:
determining an identity of an individual;
determining a destination of the individual in response to the identity; and
transmitting an elevator call to a dispatcher of the elevator system for the elevator car to transport the individual from the landing to the destination.

8. The method of claim 7, wherein the identity of the individual is determined using at least one of:
a voice of an individual captured using a microphone of the sensor system,
an image of an individual captured using a camera of the sensor system, and
a wireless signal indicating an identity of the individual detected using a communication module of the robot.

9. The method of claim 3, further comprising:
detecting a number of individuals within an elevator lobby using at least one of a people detection system of the sensor system and a people counter device of the building; and
transmitting an elevator call to a dispatcher of the elevator system in response to the number of individuals.

10. The method of claim 3, further comprising:
detecting a number of individuals approaching an elevator lobby using at least one of a people detection system of the sensor system and a people counter device of the building;
determining that a crowd has formed when the number of individuals is greater than or equal to a selected crowd size; and
transmitting an elevator call to a dispatcher of the elevator system in response to the number of individuals.

11. The method of claim 3, further comprising:
detecting a fire using a fire detection system of the sensor system;
notifying a dispatcher of the elevator system of the fire; and
operating the elevator system in an occupant evacuation operation mode.

12. A method of collecting data using a robot data collection system, the method comprising:
collecting data on a landing of a building using a sensor system of a robot;
transmitting the data to a building system manager of the building; and
adjusting operation of the building system manager in response to the data.

13. The method of claim 12, further comprising:
moving the robot around the landing to collect the data.

14. The method of claim 12, further comprising:
detecting a fire using a fire detection system of the sensor system;
notifying the building system manager of the fire; and
activating a fire alarm of the building system manager.

15. The method of claim 14, further comprising:
detecting a problem condition using the sensor system; and
notifying the building system manager of the problem condition.

16. The method of claim 12, further comprising:
capturing an image of an individual using a camera of the sensor system;
determining an identity of the individual in response to the image;
determining whether the individual is an intruder in response to the identity; and
activating an intruder alert of the building system manager.

17. The method of claim 12, further comprising:
detecting an individual within the building at an unauthorized time using a people counting system of the sensor system; and
activating an intruder alert of the building system manager.

18. The method of claim 12, further comprising:
transmitting the data to a conveyance system of the building; and
adjusting operation of the conveyance system in response to the data.

19. A method of calling an elevator car of an elevator system for a robot, the method comprising:
receiving an elevator call from the robot at a first time, the elevator call being for the elevator car to transport the robot from the landing to a destination;
obtaining a known schedule of the robot or a known location of the robot at the first time;
determining a location of the robot at the first time in response to the known schedule of the robot or the known location of the robot at the first time;
obtaining a known travel speed of the robot;
determining a time of arrival of the robot at the elevator system in response to at least the location of the robot at the first time, the travel speed of the robot, and a location of the elevator system; and
moving the elevator car to arrive at the landing at or before the time or arrival of the robot.

20. The method of claim 19, further comprising:
determining whether the robot arrived at the location of the elevator system; and
adjusting operation of the elevator system in response to whether the robot arrived at the location of the elevator system.
